(19) United States
(12) Patent Application Publication
(10) Pub. No.: US 2007/0131568 A1
(43) Pub. Date: Jun. 14, 2007

(54) Law enforcement officer's utility bag

(76) Inventors: Brian D. Georgia, Port Huron, MI (US); Paul Riddell, Port Huron, MI (US)

Correspondence Address: YOUNG & BASILE, P.C., 3001 WEST BIG BEAVER ROAD, SUITE 624, TROY, MI, 48084, US

(21) Appl. No.: 11/302,012

(22) Filed: Dec. 13, 2005

(51) Int. Cl. B65D 30/22; B65D 71/00; B60R 7/00

(52) U.S. Cl. 206/223; 224/275; 383/119; 383/40; 206/576; 206/573; 206/234

(57) ABSTRACT

A police officer's utility bag comprising a rectangular fabric body with a zippered top. Hanging file rails from any of several designs are located inside the bag below the zippered top. Side stiffeners are used to hold the shape of the bag, as well as to receive the hanging file rails and a charging fixture for a rechargeable flashlight hanging on the outside of the bag. Various pockets and pouches are provided both inside and outside of the bag. A strap attached to the top can be looped around a passenger seat headrest to hold the top open. A seatbelt clip receives a seat belt shoulder harness to secure the bag in a patrol car seat.

### FIELD OF THE INVENTION

This invention relates to utility bags made of fabric material and more particularly to a utility bag designed for use by law enforcement officers and capable of receiving and containing hanging files in an orderly manner.

### BACKGROUND OF THE INVENTION

Utility bags made of woven fabric such as Nylon have been designed for many special purposes. For example, such bags are commonly made for use by pilots in carrying charts, approach plates, VHF radios and the like. Such bags are also made for law enforcement officers and are typically of such size and shape as to be placed on the passenger seat of a patrol car so that the officer driving the car has ready access to the interior thereof. An example of a law enforcement officer's utility bag is shown in U.S. Pat. No. 4,301,898 issued Nov. 24, 1981 to Stephan E. Plough and David L. Swartzendruber.

### SUMMARY OF THE INVENTION

The present invention is a fabric utility bag having, in addition to a zippered top and an assortment of interior and exterior pockets and pouches, the capability of receiving and storing hanging files of the type having metal strips secured along the top edges and extending outwardly therefrom to form hooks which fit over parallel rigid rails. The utility bag of the present invention has interior structure to receive hanging files running lengthwise, crosswise, or both, and to maintain the cross-section shape of the bag. As such the utility bag of the present invention is particularly well-suited for use by police officers assigned to patrol car duty.

One of the features of the utility bag of the present invention is the use of stiffening boards on the interior of the side panels to hold the bag in shape. In addition, hanging file rails are secured to or integrally formed with the inside surfaces of the side panels to receive hanging files. Alternatively or additionally, rails may be mounted parallel to the front and rear panels just below the top edges of the front, rear and side panels and spaced outwardly from said panels to receive hanging files. In one illustrative embodiment, the rails are made integral with the stiffening boards and the boards are fitted into slotted side pockets on the interior of the bag.

Also in the preferred embodiment, the bag is equipped with a charging fixture which receives and charges a commercially available flashlight. The charging fixture is mounted on the outside surface of one of the side panels. A pocket to receive and hold a charging cord is preferably disposed immediately adjacent the area occupied by a flashlight in the charging fixture. The charging fixture is secured to the bag by fasteners which go through the bag and into the stiffening boards.

Additional features and advantages of the illustrative embodiment of the present invention include a seat belt clip which helps secure the bag in position on the passenger seat of a patrol car, numerous pockets on the interior of the hinged top, a strap which can be deployed and looped over, for example, an automotive seat headrest to hold the top of the bag in the open position, and a one-sided saddle bag which is removably secured to the bag to overlie the exterior of the rear surface thereof to provide additional storage capability.

### BRIEF DESCRIPTION OF THE DRAWINGS

FIG. 1 is a perspective view of a utility bag constructed in accordance with the present invention on the passenger seat of an automobile with the top of the bag held open by the top loop;

FIG. 2 is a perspective view of the utility bag of FIG. 1 with the top open and a rear-mounted single-sided saddle bag in place;

FIG. 3 is a perspective view of the utility bag of FIG. 2 with the top closed showing an illustrative arrangement of straps to hold the saddlebag in place;

FIG. 4 is a sectional view through one of the side panels of the bag of FIG. 1 showing how a stiffening board with integral hanging file rail is held in place;

FIGS. 5, 6 and 7 illustrate various embodiments of structures for mounting hanging file side rails; and

FIG. 8 is a further illustrative embodiment showing a system for providing both side-to-side and front-to-back hanging file rails thereby to accommodate hanging files of different sizes.

### DETAILED DESCRIPTION OF THE ILLUSTRATIVE EMBODIMENTS

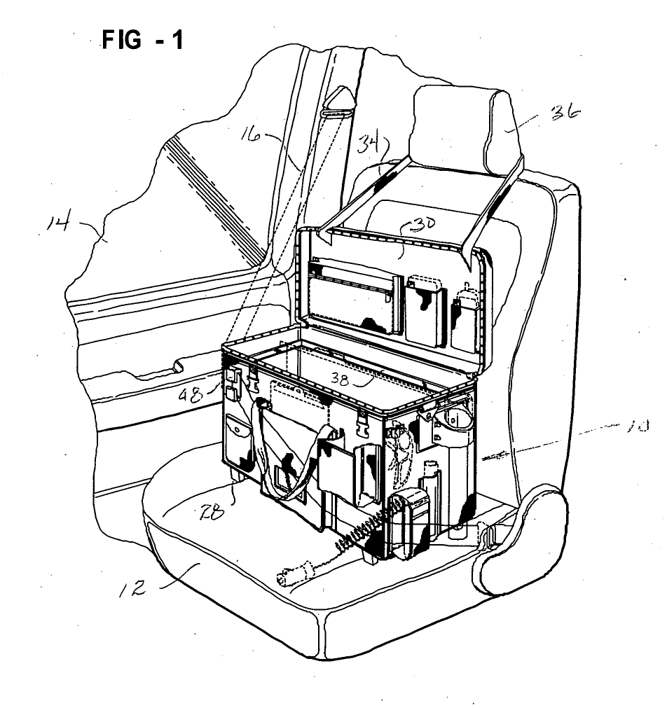

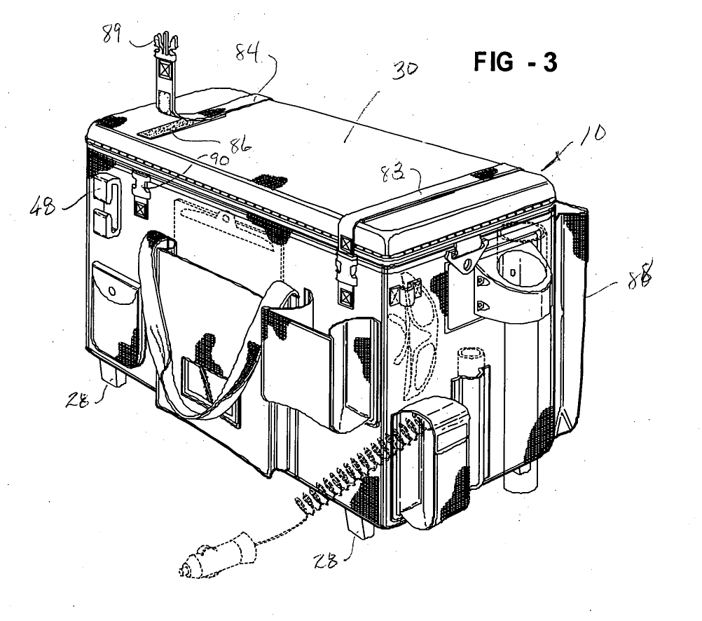

As shown in FIGS. 1, 2 and 3, the illustrative embodiment of the invention comprises a fabric utility bag 10 made of tightly woven ballistic Nylon. The bag 10 is shown resting on the passenger seat 12 of a police cruiser 14 equipped with a standard seat belt shoulder harness 16. The bag is rectangular and is approximately 16 to 20 inches wide by 10 inches deep by 12 to 14 inches high. The bag 10 comprises a front panel 18, a rear panel 20, side panels 22 and 24, and a bottom 26 with hard plastic feet 28 riveted to the bottom and to a stiffener panel (not shown) within the bottom to help maintain the shape of the bag 10. A top 30 also made of ballistic Nylon is hingedly secured to the back panel 20 as and is provided with a zipper 32 which runs around three sides of the bag; i.e., along the top edges of side panels 22 and 24 and the front panel 18. A strap 34 which is preferably elastic is attached to the top 30 on the inside surface thereof and can be looped around the headrest 36 of the seat 12 to hold the top 30 in an open position. An outside attachment is also acceptable.

In accordance with the invention, a substantially rigid frame 38 is secured to the inside surfaces of the front and rear panels 18 and 20 approximately two inches below the top edges of the side panels 22 and 24. The frame 38 may be made of metal or plastic and is riveted to and through the front and back panels 18 and 20. Frame 38 includes parallel rigid side rails 42 which stand out approximately ⅜ of a inch from the side panels 22 and 24 to accommodate the hooks 46 of conventional hanging file folders 44 which, in this case, are legal size so as to extend side to side along the longer dimension of the bag 10. Dividers (not shown) may also be used to separate the file folder area of the bag into several separate compartments as desired. The dividers may be cushioned to protect, for example, a lap top computer.

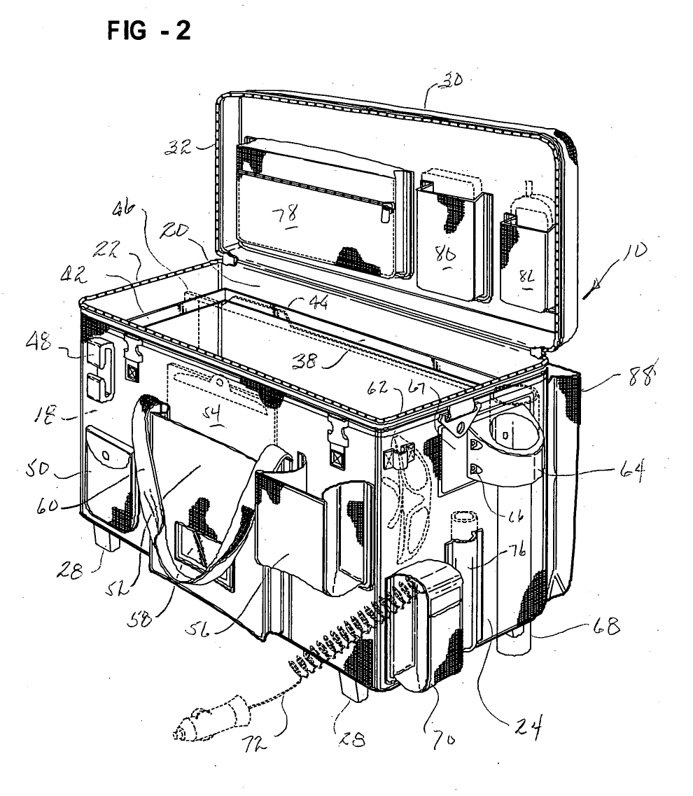

A further feature of the bag 10 is a molded plastic seatbelt clip 48 which is suitably secured such as by rivets or screws to the bag 10 near the upper front left corner as shown in FIGS. 1, 2 and 3. The clip receives the shoulder harness 16 of the seatbelt system of the automobile 14 to hold the bag 10 in place on the seat 12 during normal patrol car use. With the top 30 open as shown in FIGS. 1 and 2, access to the interior of the bag 10 is easily achieved so as to locate and remove the proper forms such as citations, accident report forms and the like.

Further features of the bag 10 comprise a snap covered pocket 50 on the front panel 18 along with a pouch 52 for a clipboard 54 and a pouch 56 for drink cans or other cargo of similar size and weight. The sizes and shapes shown are merely illustrative. A clear plastic panel 56 is provided for business cards or an identification card as desired. Carry straps 60 are secured to the front panel 18 and the rear panel 20 of the bag 10 for normal transportation between, for example, a station house and the patrol car. The straps 60 are made of Nylon webbing or other suitable fabric material.

Further features of the bag 10 mounted on the right hand side panel as shown in FIG. 2 include a sunglasses clip 62 and a commercially available charging fixture 64 for a flashlight 68. Suitable fasteners such as rivets 66 are used to secure the charging fixture 64 to the stiffening panel 67 which can be mounted either on the inside or outside surface of the right hand side panel 24 as desired. Seamed holes are preferably provided in the Nylon fabric of the bag to receive the rivets or screws to hold the fixture 64 in place. A covered pocket 70 for a charging cord and plug 74 is provided adjacent the area occupied by the charging fixture 64 and the flashlight 68 so as to make it convenient to charge the flashlight when the bag 10 is mounted within the patrol car as shown in FIG. 1. The charging cord is pre-wired to the fixture 64. An additional pouch 76 for an additional flashlight may be provided as desired. A suitable chargeable flashlight and charging ring is made by Streamlight®. The flashlight 68 carries a “battery stick” which, in a preferred embodiment, is the equivalent of five “C” cell batteries. While a ring-like fixture 64 is illustrated, other types of charging fixtures and/or brackets, as well as other types and sizes of flashlights, can be used.

On the inside surface of the top 30, a combination pouch and zippered bag 78 is provided to hold, for example, a small pencil box, along with additional pouches 80 and 86 to hold miscellaneous items such as a small record book, an electronic organizer, and a cell phone as shown.

A one-sided saddle bag 88 also made of fabric is mounted on the outside surface of the back panel 20 by way of straps 83 and 84 which are secured by Velcro strips 86 to the outside surface of the top 80 when the saddlebag 88 is attached. The straps 83 and 84 terminate in resilient clip fastener 89 which constitute the male member for the female fastener receivers 90 mounted by stitching to the front panel 18 of the bag 10. The Velcro fasteners 86 permit the saddlebag straps 83 and 84 along with the saddlebag 88 to be removed as desired.

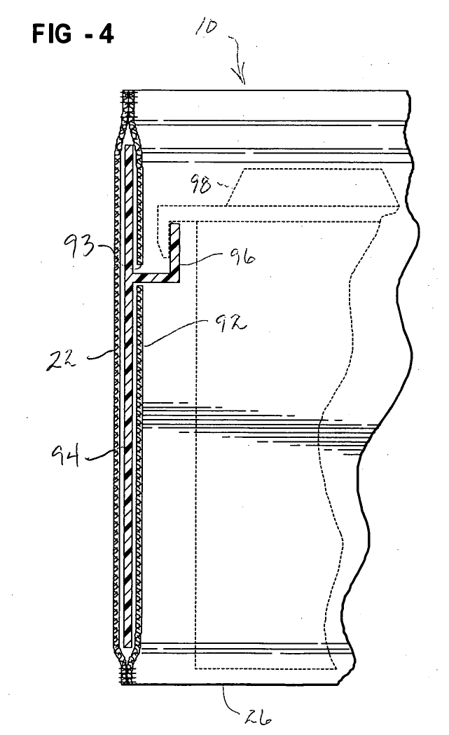

Looking now to FIG. 4, one of the side panels 22 is shown in section to comprise a double wall including an interior fabric panel 92 having a slot opening 93 to receive a rectangular plastic stiffening board 94 therein. In practice, a brand 94 is provided in each side panel 22 and 24. The board 94 is provided with an integral plastic rail 96 which is adapted to receive the metal hook of a conventional hanging file folder 98 as shown.

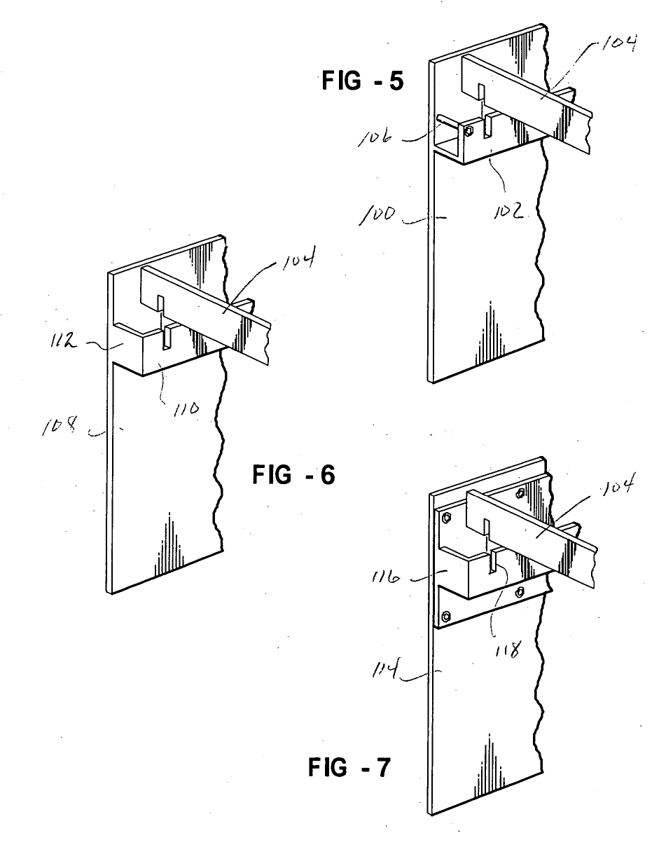

Looking now to FIGS. 5, 6, 7 and 8, various alternative ways for providing the rails for the file folders will be described. In FIG. 5 a stiffening board 100 made of plastic has an integral L-shaped hanging file rail 102 formed thereon. The hanging file rail is terminated by a rivet or screw-type fastener 106 to prevent files from sliding off the ends.

The rail 102 is slotted as shown to receive a perpendicular rail 104 which can be inserted as desired to convert the bag 10 into assist for receiving narrower hanging files arranged front-to-back rather than side-to-side in the bag 30.

FIG. 6 shows a similar arrangement in which the stiffening side board 108 is provided with an integral rail 110 having closed ends 112 in place of the fastener-type termination 106. Again, a snap-in, slotted conversion rail 104 is provided so that both long side-to-side legal size files as well as narrower front-to-back files can be hung within the bag 30.

FIG. 7 shows a still further arrangement in which the side board 14 has a molding 116 attached thereto by rivets or the like. The molding 116 provides a closed end rail with a slot 118 to receive the conversion rails 104.

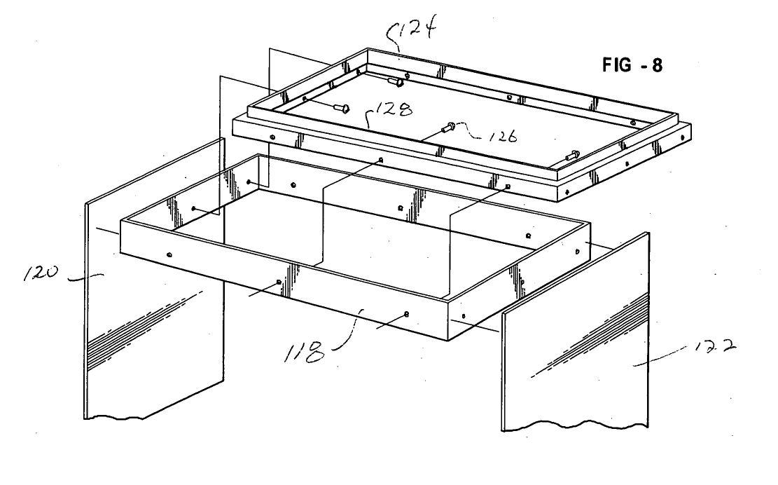

FIG. 8 shows a still further embodiment of the invention in which a rectangular frame 118 is secured by rivets 120 or the like to side stiffener boards 120 and 122 as well as to the front and back panels (not shown) of the associated bag to provide a solid rectangular frame which may be made of metal or plastic.

To the frame 118 is mounted a second interior frame 124 having a rectangularly arranged recessed rail 128. Integral therewith to accommodate hanging file folders in either side-to-side or front-to-back relationship. It will be apparent to those skilled in the art that numerous other arrangements for receiving hanging file folders may also be used. The lengthwise, legal size hanging file systems shown in FIGS. 1 and 2 can be converted to letter size files by snapping in an adapter cross-rail at the approximate location.

It has been found that the utility bag of the present invention is particularly useful for the duties of civilian police officers, particularly officers assigned to single officer patrol duty in a police vehicle. Of course the bag may be used for various other purposes and persons as will be apparent to those skilled in the art. For example, military personnel traveling in various types of vehicles, pilots of airplanes, helicopters and airships, strip officers and explorers may find the bag of the present invention useful in the form shown or in customized variations of it.

1. A police officer's utility bag comprising:
a generally rectangular fabric body defining a front panel, a back panel, a pair of side panels and a floor;
a fabric top zippered to the body around the front and side panels and hingedly connected to the back panel so as to be capable of being folded back when opened;
stiffening boards secured to the side panels to maintain the shape of the bag; and
first and second substantially rigid parallel rails extending along at least one of the front and rear panels and the opposite side panels in outwardly spaced relationship thereto to receive and support hanging files within the bag.

2. The utility bag described in claim 1 further including a strap attached to the top and engagable with or around a fixed object to hold the top in the open position.

3. The utility bag as described in claim 1 wherein the first and second rails are mounted on the side panels proximate but spaced below the top edges thereof.

4. The utility bag as described in claim 3 wherein the first and second rails are attached to the stiffening boards.

5. The utility bag as described in claim 1 wherein the first and second rails are integral with the stiffening boards and are made of plastic.

6. The utility bag as described in claim 5 wherein means are provided for closing the ends of the first and second rails.

7. The utility bag as described in claim 3, wherein the first and second rails are attached to the interiors of the front and back panels.

8. The utility bag as described in claim 3, wherein the distance between the first and second rails is approximately 14 inches.

9. The utility bag as defined in claim 1, further including containers secured to the exterior of the front and side panels.

10. The utility bag as described in claim 9, wherein the containers are selected from the group consisting of pockets and pouches.

11. The utility bag as described in claim 1 further including a recharger fixture secured to the exterior of one of the side panels for receiving a flashlight.

12. The utility bag as described in claim 11, further including an exterior pocket secured to the exterior of one of the side panels adjacent the flashlight charging fixture and containing a charger cord.

13. The utility bag as described in claim 1 further including a seat belt clip mounted on the exterior of the bag, the overall shape and size of the bag being such as to fit on a passenger seat of an automobile, the seat belt clip being in a position to receive the shoulder portion of an automotive seat belt to hold the utility bag in the passenger seat.

14. The utility bag as described in claim 1 further including a plurality of containers such as pockets and pouches mounted to the inside surface of the top.

15. The utility bag as described in claim 1 further including means to stiffen the bottom of the bag and a plurality of feet attached to the outside surface of the bottom.

16. The utility bag as described in claim 1 further including a pair of carry straps extending upwardly from the bag to assist in carrying same.

17. The utility bag as described in claim 1 further including a single-sided saddle bag and means for attaching the saddle bag to the utility bag in overlying relationship to the rear panel of the bag.

18. The utility bag as described in claim 1 further including a double wall on each of said side walls to receive said stiffening boards said double walls including an open slot adjacent but spaced from the top of the side panels, said hanging file rails protruding through said slots into the interior of the bag.

19. The utility bag as described in claim 1 wherein the fabric is tightly woven Nylon.

20. A utility bag comprising a rectangular body of woven fabric forming front, back, side and bottom panels, a top zippered to the side and back panels, and a rigid frame attached to the side, front and back panels in the interior of the bag below the zippered top to accommodate hanging files.
